(19) United States
(12) Patent Application Publication
(10) Pub. No.: US 2007/0300149 A1
(43) Pub. Date: Dec. 27, 2007

(54) COMPUTER SYSTEM

(75) Inventors: Clive Bryant, Northampton (GB); Dylan Bartlett, Birmingham (GB); Chris Lawton, Birmingham (GB)

Correspondence Address: BARNES & THORNBURG LLP, P.O. BOX 2786, CHICAGO, IL, 60690-2786, US

(73) Assignee: GEMS TV LTD., West Midlands (GB)

(21) Appl. No.: 11/465,828

(22) Filed: Aug. 21, 2006

(30) Foreign Application Priority Data
Jun. 27, 2006 (GB) 0612673.4

(51) Int. Cl. G06F 17/00

(52) U.S. Cl. 715/513

(57) ABSTRACT

A web page element updating system comprising a central data source, having a processor and a memory, a plurality of primary web pages, an embedded web page within each of the plurality of primary web pages, means for obtaining data from the embedded webpage to an element of the primary webpage, a correlator for correlating an identifier of data within the embedded web page with a label of the element, wherein each primary web page comprises an element with an associated label, each embedded web page contains data with an identifier corresponding to the label of the element, the central data memory is in communication with the embedded web page and the processor is configured such that new data entered into the central data memory is transmitted from the memory to the embedded webpage where it is held with an identifier, the correlator is configured to correlate the data with the appropriate identifier to the corresponding element using its label, and the means for obtaining is configured to use the data that has been correlated to the element to update the element.

### CROSS-REFERENCE TO RELATED PATENT APPLICATIONS

This patent application claims priority to United Kingdom patent application no. GB 0612673.4, filed Jun. 27, 2006, the content of which is herein incorporated by reference in its entirety.

### FIELD

This disclosure relates to a system for changing web site pages in response to changes at a centralised source, in particular to ensure that all use of the web site pages view updated changes at the same time.

### BACKGROUND & SUMMARY

In some instances it is desirable to allow synchronisation of web pages and possibly synchronisation of web pages with another media. For example, TV based auctions can be designed to allow participation through web pages as well as allowing television viewers to participate via telephone. In those circumstances the web page users may not be watching the television channel and it is therefore important to ensure that changes happening to the auction on TV are simultaneously provided to users of the web pages so that none of the users have an advantage in terms of reacting to any updated situations.

One way of synchronising changes across web pages would be to have them generated by identical automated algorithms. However, where there are non automated changes at a centralised source that need to be distributed to web pages, such a system may not work. For instance in the example of a TV based auction the prices may be controlled by a human television producer and therefore these changes cannot be replicated by an automated algorithm and require an alternative method to be synchronised across web pages.

Push technology is known to be used for delivery of changes through the Internet. Most commonly this can be used in so called push e-mail, which rather than requiring the end user to pull through e-mail as desired pushes any new e-mail through to the user, for example via a mobile device, as soon as it is detected. However, this may be unsuitable where there are a large number of current users who all need the same synchronised information, since this may require a large number of web servers. Additionally, it may be blocked by Internet firewalls.

There are several mechanisms for presenting changes in web pages such as Active X components, Macromedia Flash etc., but these require specific downloads and therefore cannot be used instantly by a new user. Other outlets such as Java or Ajax may be treated differently by different browsers and therefore may give slightly different changes to different users. In the case of an auction it may provide an advantage to users of a certain web browsers.

According to a first aspect of the disclosure there is provided a web page element updating system comprising a central data source, having a processor and a memory, a plurality of primary web pages, one or more embedded web page within each of the plurality of primary web pages, means for obtaining data from the embedded webpage to an element of the primary webpage, a correlator for correlating an identifier of data within the embedded web page with a label of the element, wherein each primary web page comprises an element with an associated label, each embedded web page contains data with an identifier corresponding to the label of the element, the central data memory in communication with the embedded web pages on a timer basis appropriate for the implementation. As such, they are not truly connected, as this implies some form of permanent connection and the processor is configured such that new data entered into the central data memory is transmitted from the memory to the embedded webpage where it is held with an identifier, the correlator is configured to correlate the data with the appropriate identifier to the corresponding element using its label, and the means for obtaining is configured to use the data that has been correlated to the element to update the element.

In one embodiment, one or more of the primary web pages may comprise a plurality of elements with different labels. In another embodiment, new data may be held with a plurality of portions tagged with different identifiers corresponding to the different labels, and the correlator is configured to correlate portions of data to the corresponding elements by matching identifiers to labels.

In another embodiment, the means for obtaining comprises a wrapper in which the embedded web page is embedded, and the wrapper may be embedded in the primary web page and may function as its own web page and/or the wrapper can take data from the embedded web page within and send data to element(s) of the primary web page.

The memory may contain a caching program and the processor is configured to use the caching program to store the data sent to the embedded web page in the memory. In another embodiment, there is provided a comparator for comparing the new data from the central source against the data stored by the caching program and configured to send data to the embedded web page dependent on comparisons made between new data and stored data. In another embodiment, the comparator is configured to compare each portion of the data to the most recently stored data portion stored by the caching program which has the identical or corresponding identifier, and/or the system only sends data or portions of data to the embedded web page that is different to the corresponding data stored.

The system may update the element(s) repeatedly after set time periods. In another embodiment, where the update is made by the system using the correlator, comparator, and/or obtaining means in the manner defined in any preceding claim, and/or an update after a given time period will not result in a change to an element if the comparator calculates there has been no change in the data/data portion with the identifier that corresponds to that elements label, optionally wherein such a calculation leads to a blank page being sent to the embedded web page and/or to replace the embedded web page.

There may be provided a web page element updating system comprising a plurality of servers in communication with the central data source and one or more browsers hosting the primary web pages, the connection between the daemon and embedded web page being via a web server. In one embodiment, one or more web servers are connected to a plurality of browsers. In one embodiment, data sent from the central data source to the web server is stored using a single server instance data object. One or more web browsers may comprise a plurality of server per viewer data objects, optionally one for each connected browser, the data being sent from the single instance object to the browser via the sever per viewer instance data objects, or the data being retrieved by the browser via the server per viewer instance data object and/or the comparator compares information at the web server such as at the single instance data object and/or the per-viewer instance data objects with the data in the store.

There may be provided a database, which may for example be on another server, which the processor is configured to update with data being sent to update the elements. The element may be updated using dynamic hypertext mark up language (DHTML). Elements may be defined by div tags in the html of the primary web page and/or the identifier and/or label comprises a div ID.

In one embodiment, the central memory comprises multiple memory sources on multiple computers servers in communication with each other such as web servers and/or the processor is configured so as to comprise the comparator, and/or correlator.

The system may comprise a temporary connection between the central memory and the embedded web page, the central data memory being in communication with the embedded web page over the temporary connection, optionally wherein a temporary connection is created whenever data needs to be or is requested to be transferred between them and may be terminated when it does not or is not.

According to an aspect of the disclosure there is provided a method of updating an element in a web page comprising the steps of associating a label with an element of a primary web page, providing an embedded web page within the primary web page containing data at least part of which has an identifier corresponding to the label of the element, updating the data in the embedded web page from a central source, obtaining data from the embedded web page and supplying a selected part of the data to the element by correlating the identifier with the label.

In one embodiment, there is provided a method of running a falling- or rising-price auction comprising the steps of displaying events in the auction via an element or elements on a plurality of web pages, wherein change to prices in the auction are displayed by updating the element(s) according to an aspect of the disclosure.

There can be provided a method of running an auction comprising the steps of displaying events in the auction via an element or elements on a plurality of web pages and via another media, wherein new events occurring on the other media are presented to viewers of the web pages at a controlled time and may be substantially simultaneously to the viewers of the another media by updating the element(s). The another media may be a television channel.

Benefits of the disclosure can include that it can create dynamic elements for any web-based page, whether text, images, hyperlinks, other embedded objects (such as video or Macromedia flash). It can update an element that would link to a different subset of data that would in turn load a different main page to give a completely different experience. It can affect Cascading Style Sheets to give a different look to the page for each client and/or event.

Embodiments of the disclosure will now be described, by way of example only, with reference to the accompanying figures in which:

### BRIEF DESCRIPTION OF THE DRAWINGS

FIG. 1 is a schematic view of the architecture of a system in accordance with the disclosure;

FIG. 2 is a schematic view of a web page updated in accordance with the disclosure;

FIG. 3 is a flow diagram of a process of updating web server and a database in accordance with the disclosure; and

FIG. 4 is a flow diagram of a process of updating web pages in accordance with the disclosure.

### DETAILED DESCRIPTION

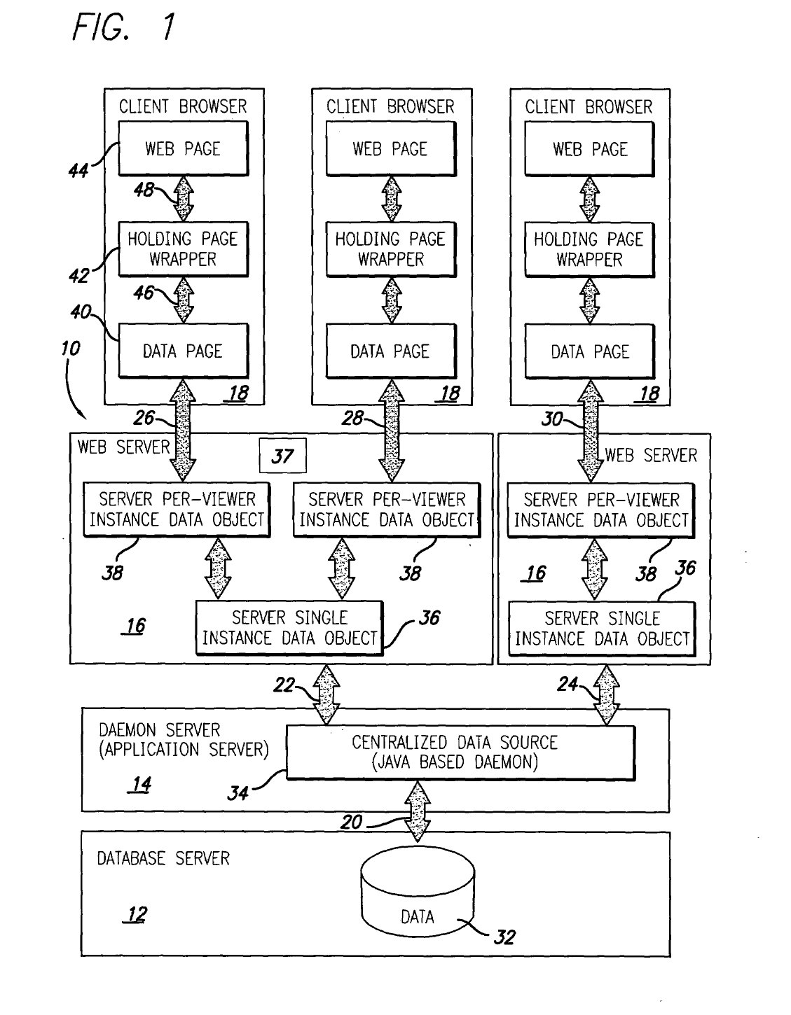

Referring to FIG. 1, there is shown a system 10 comprising a database server 12, an application or daemon server 14, web servers 16 and client browsers 18. There are two web servers 16 and three browsers 18 in the illustrated example. The components are linked with a direct database connection (JDBC) 20 between the database server 12 and daemon server 14, HTTP Internet protocol connections 22 and 24 between the daemon server 14 and the web servers 16, and HTTP Internet protocol connections 26, 28 and 30 between the web servers 16 and the client browsers 18. As shown in FIG. 1 there can be multiple or a single client browsers 18 for each web server 16 with an IP connection 26, 28, 30 between each client browser 18 and its corresponding web server 16. Connections 22, 24, 26, 28 and 30 need not be permanent connections. The connections may be temporary, with a connection being made and broken as and when the components need to communicate with each other.

The database server 12 comprises a database 32 containing data concerning all current and historical events and changes. The database 32 may be used for post operation analysis such as calculating the correct invoice for a successful participant in an auction and may also be used “real time” as part of the operation itself. For example in the case of the auction a television presenter may access the database 32 for guidance and/or it might be used to display information of television screens.

The daemon server 14 has a java based daemon 34 which acts as the centralised news source. The daemon 34 has a single connection with the database 32 via JDBC connection 20 and has at least one IP connection 22, 24 to each web server 16. It is from this daemon 34 that changes to data are made to be distributed across the system 10 via push- or pull-methodologies. This daemon effectively forms the centralised source at which changes to the data can be made and from which updates can be drawn. In a particular example this may be the data relating to changes made to a TV auction where database 32 is used not only for system 10 but for a simultaneously broadcast TV program. So for example, should a human TV producer reduce the price in an auction this change to the recorded price will be sent to database 32, possibly for use for television, and also for distribution to the web servers 18 too. Because the connection 20 is two way changes may instead be made directly to the database 32 and replicated to the centralised news source daemon 34.

Each web server 16 contains a single instance data object 36 and one or more server per viewer instance data objects 38. The server single instance data object 36 is connected to the daemon server 14 via a single IP connection 22, 24. There are generally a number of server per viewer instance data objects 38 equal to the number of client browsers 18 connected to that web server 16. The per viewer instance data object 38 has memory based access to a single instance data object 36 and vice versa. Using the combination of single instance data objects 36 and per viewer instance data objects 38 it is possible to keep only one main copy of new data per web server 16, with multiple references from the one copy for use by each of the client browsers 18. Accordingly this can save on memory usage. There can be a large number of client browsers 18 attached to a single web server 16 and the use of single instance data objects 36 means that this data does not always have to be stored a large number of times for each client browser but can be stored as a single copy with multiple references.

The web server also comprises a caching algorithm component 37 which compares and caches into the server memory in order to reduce unnecessary bandwidth transmitting data to the client which is identical to data that the client already possesses.

The client browser 18 is likely being driven by a separate client PC and hosts a data page 40, holding page wrapper 42 and primary web page 44. It is the data page 40 that is connected via the IP connection 26, 28, 30 to a web server 16. Connections between the data page 40, holder page wrapper 42 and primary web page 44 are via dynamic HTML JavaScript connections 46 and 48.

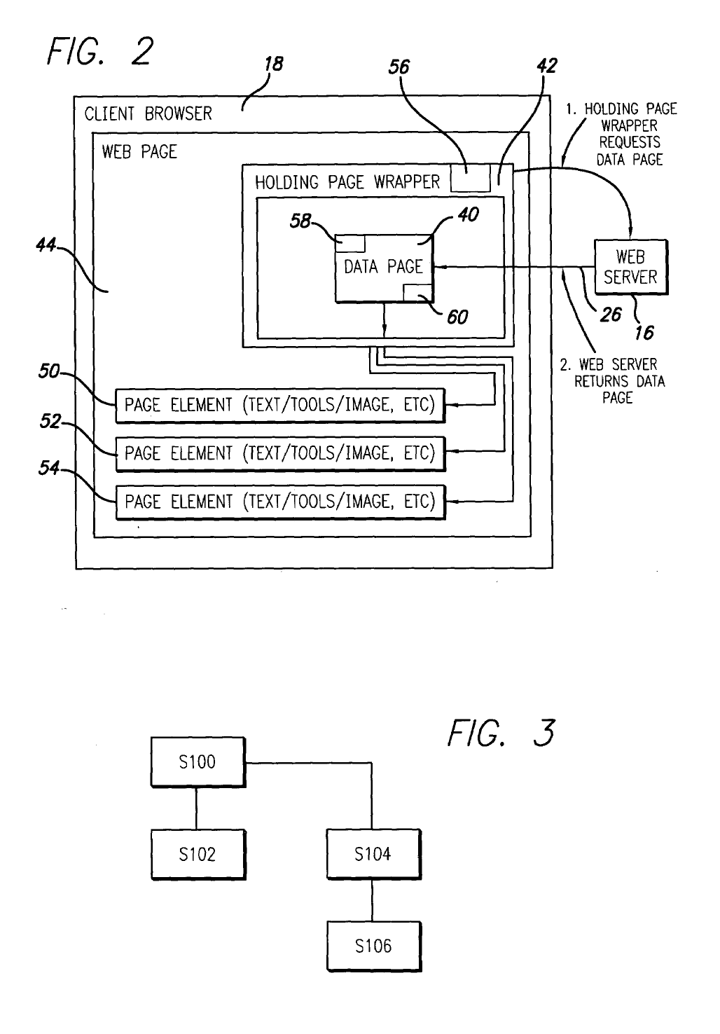

The construction of the web page 44 and its relation to data page 40 can be seen best in FIG. 2. In FIG. 2 it can be seen that the holding page wrapper 42 is embedded within the web page 44 and the data page 40 is embedded in the holding page wrapper 42.

The web page 44 comprises a series of HTML page elements 50, 52 and 54. There may be any number of such elements which can be in the form of a text, table, image or any other normal web page element. The web page elements can be 50, 52, 54 formed by “div” tags (written as <div></div>) in the code of the web page 44 that contain a portion of the (hypertext markup language) HTML. Typically, each div tag has a unique identifier within the page enabling it to be addressed. Alternatively, div tags may share identifiers, in which case they will update simultaneously. This decision is at the discretion of the page designer. Using a reference to the identifier, the content between the enclosing “div” tags can be changed using JavaScript; as is standard with Dynamic HTML. Div tags can contain nested Div tags which may contain more nested tags ad-infinitum. Each of the portions positioned between div tags can be identified by virtue of their positioning between identifiable tags and therefore in effect each has a “label”.

The data page 40 sits as an embedded iframe element within the holding page wrapper 42 and the holder page wrapper 42 sits as an embedded iframe element in the primary web page 44. Accordingly, each of web page 44, holding page wrapper 42 and data page 40 are in effect their own web pages with all of the uses and applications this brings. For example all three have access to cookies stored on a client PC hosting the browser 18.

Because of the nature of the embedding of the pages the “parent” can talk to the “child” in order to obtain data from it and the “child” can talk to the parent to update elements contained in it. Accordingly the web page 44 can seek to obtain data from the holding page wrapper 42 and likewise, holding page wrapper page 42 can update data in web page 44. Similarly data page 40 can update information in holding page wrapper 42 and holding page 42 can look for new data in data page 40.

The holding page wrapper 42 comprises timing logic component 56 which forms part of the general java script of the holding page wrapper 42.

The data page 40 comprises delimited text that indicates the place holder name 58 and the data that needs to be updated 60.

In FIG. 3 is shown a flow chart of a process of updating data within the web page 44 from the centralised data source daemon 34. In this particular example the process is related to the use in an Internet site being used as part of the TV auction.

At step S100 new data is created at the daemon server 14 on the java based daemon 34.

Step S102 and step S104 are taken substantially simultaneously. At step S102 the new data is updated in the database 32 on database server 12. Alternatively the data from daemon 34 may be changed in the database 32 and then sent into the daemon server 14 via the direct database connection 20.

At step S104 a serialised java object or a set of objects corresponding to the data in the centralised data source 34 is retrieved by each web server 16 via each HTTP IP connection 22, 24 in each instance being sent to a single instance data object component 36. This data is then stored as a single instance data objects 36 at step S106. Then at S108 at each web server 16 the information in each single instance data object 36 is replicated either as a reference or in the form of a copied data to the server per viewer instance data objects 38. When a new client logs on to the web site a new server per viewer instance data object 38 will be created to correspond to the new client browser 18 and replicate or make reference to the existing single instance data object 36. The data will then remain stored in the web server 16 until requested by the client browser 18.

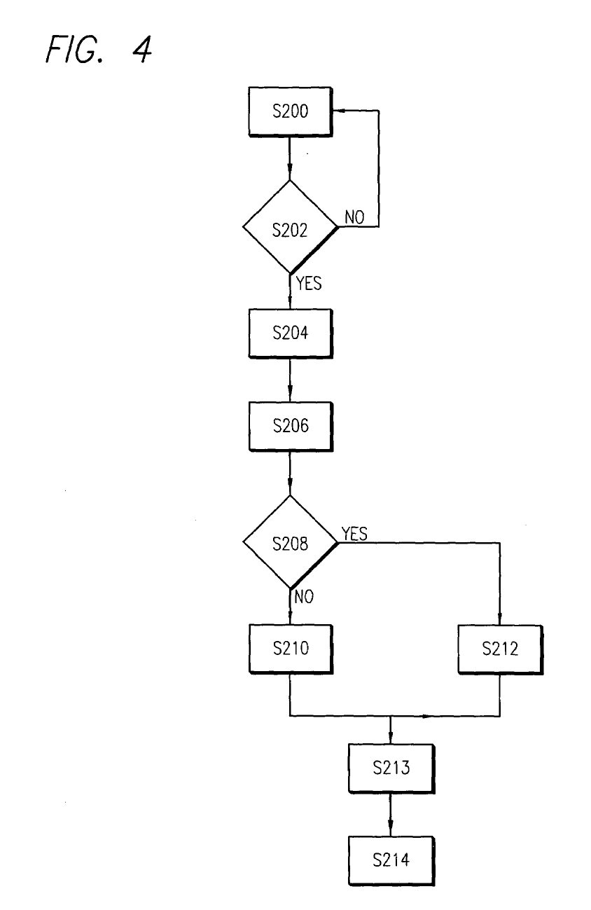

In FIG. 4 is shown the process of a web page 44 in a client browser 18 being updated from the centralised data source 34.

At step S200 the holding page wrapper 42 refreshes its data page 40. The regularity with which this is done is governed by the timing logic component 56 contained within it. Typically this may be every few seconds but will depend upon the particular application. In the instance of the Internet auction it will need to be every couple of seconds or so in order to ensure that the users on the Internet are not disadvantaged versus those guided by the television.

At step S202 the timing mechanism 56 asks whether a time period greater than predetermined period (stored for example in the memory of the web server 16) has expired since the process last proceeded to step S204. If the answer is no, then it returns back to step S200 and if yes it proceeds to step S204. At S204 the holding page wrapper 42 sends a request to the web server 16, that corresponds to the client browser 18, for a new data page. At step S206 the server per viewer instance data object 38 corresponding to the browser 18 receives the request and compares the data currently held in its main storage against that cached by the caching algorithm component 37. It will only compare against the most recently cached data page.

At step 208 the processor of the web server 16 calculates from the comparison whether there are any alterations between the cached data and the presently held data. If the answer is no the process goes to step 210 and if the answer is yes it proceeds to step 212.

At step S210 a blank data page is returned to client 18 consuming a minimal amount of bandwidth. The subsequent data page 40 embedded in wrapper 42 then contains no data in component 60. At step S212 a data page is sent which contains updated information. The data page is sent via the HTTP connection 26, 28, 30 and is sent in the form of HTML over standard port 80. It is sent in the form of delimited text and contains the data that needs to be updated and the place holder name 58.

The data page contains pairs of matched div IDs and data, with the div IDs acting as the place holder name 58. A suitable advisable format is: ̂##̂[div ID]˜[div data]

Where the characters ̂##̂ indicate a delimiter between ID: data pairs. The tilde delimits the ID 58 from the data 60. Any sequence of characters could be used for these purposes as long as the IDs 58 used for the Divs do not contain the delimiter characters.

A modification on this can be made to allow more explicit identification of Div IDs 58 in the form: ̂##̂:[div id]˜[div data]˜[div id]:

That way, the closing div id 58 needs to match the opening div id to stop erroneous data handling. This is especially useful where content to be sent to the client contains large chunks of data that can span across multiple text lines. In that sense the prior form described above is a short-hand of this more complete modification. Any shorthand improves the overall performance is particular by reducing bandwidth consumption.

At step S213 the new data page, as well as being transmitted to the client browser 18, is also stored in a memory by the caching algorithm function 37 so that it can be compared against the presently stored data whenever step S208 is next undertaken. The cached form for comparison is the composite of data with each of the last sent div ID's so that the Div IDs are used to catalogue the last-sent data at the web server on a per-session basis. In the case of nested Div the change of any parent Div results in the child div being refreshed also by the caching algorithm component 37. The process then continues to step 214.

At step S214 the receipt of a new data page 40 triggers the holding page wrapper 42 to dispute new data. At step S216 it compares any place holder names 58 to the place holder name of page elements 50, 52 and 54 using its position or “cached”. Where the place holder names, match the holding page wrapper 42 takes the data, and use this to change the corresponding page element 50, 52, 54 using dynamic HTML.

In the example given above the data 60 taken will be that part after the tilde where the div IDs 58 match.

In the case of the process proceeding via step S210 then there will be no data 60 or place names 58 to update.

The system is particularly beneficial for controlling a web-based falling price auctions for items, ensuring that all clients see the same prices at the same time. It can also be used to create a web-based chat room system, ensuring that all users see the same things happening at substantially the same time.

Because the embedded iframes 40 and 42 are pages in their own right using standard web requests, the web servers have access to cookies within the requests in order to control login, membership, or other such information about the client, without any need for sophisticated mechanisms.

The system 10 described uses the java programming language, however on the server side the disclosure could use any suitable programming language. The system 10 is described with a single Daemon 34. Instead, there could be multiple daemons, or applications servers using CORBA, Dot Net, or the like.

What is claimed is:

1. A web page element updating system comprising a central data source, having a processor and a memory, a plurality of primary web pages, an embedded web page within each of the plurality of primary web pages, means for obtaining data from the embedded webpage to an element of the primary webpage, a correlator for correlating an identifier of data within the embedded web page with a label of the element, wherein each primary web page comprises an element with an associated label, each embedded web page contains data with an identifier corresponding to the label of the element, the central data memory is in communication with the embedded web page and the processor is configured such that new data entered into the central data memory is transmitted from the memory to the embedded webpage where it is held with an identifier, the correlator is configured to correlate the data with the appropriate identifier to the corresponding element using its label, and the means for obtaining is configured to use the data that has been correlated to the element to update the element.

2. A web page element updating system wherein one or more of the primary web pages comprises a plurality of elements with different labels.

3. A web page element updating system according to claim 2, wherein new data is held with a plurality of portions tagged with different identifiers corresponding to the different labels, and the correlator is configured to correlate portions of data to the corresponding elements by matching identifiers to labels.

4. A web page element updating system according to claim 1, wherein the means for obtaining comprises a wrapper in which the embedded web page is embedded.

5. A web page element updating system according to claim 4, wherein the wrapper is embedded in the primary web page and functions as its own web page.

6. A web page element updating system according to claim 4, wherein the wrapper can take data from the embedded web page within and send data to element(s) of the primary web page.

7. A web page element updating system according to claim 1, wherein the memory contains a caching program and the processor is configured to use the caching program to store the data sent to the embedded web page in the memory.

8. A web page element updating system according to claim 7, comprising a comparator for comparing the new data from the central source against the data stored by the caching program and configured to send data to the embedded web page dependent on comparisons made between new data and stored data.

9. A web page element updating system according to claim 8, wherein the comparator is configured to compare each portion of the data to the most recently stored data portion stored by the caching program which has the identical or corresponding identifier.

10. A web page element updating system according to claim 8, wherein the system only sends data or portions of data to the embedded web page that is different to the corresponding data stored.

11. A web page element updating system according to claim 1, wherein the system updates the element(s) repeatedly after set time periods.

12. A web page element updating system according to claim 11, where the update is made by the system using the correlator, comparator, and/or obtaining means in the manner defined in any preceding claim.

13. A web page element updating system according to claim 11, wherein an update after a given time period will not result in a change to an element if the comparator calculates there has been no change in the data/data portion with the identifier that corresponds to that elements label, wherein such a calculation leads to a blank page being sent to the embedded web page and/or to replace the embedded web page.

14. A web page element updating system according to claim 1, comprising a plurality of servers in communication with the central data source and one or more browsers hosting the primary web pages, the connection between the daemon and embedded web page being via a web server.

15. A web page element updating system according to claim 14, where one or more web servers are connected to a plurality of browsers.

16. A web page element updating system according to claim 15, wherein data sent from the central data source to the web server is stored using a single server instance data object.

17. A web page element updating system according to claim 16, wherein one or more web browsers comprises a plurality of server per viewer data objects one for each connected browser, the data being sent from the single instance object to the browser via the sever per viewer instance data objects, or the data being retrieved by the browser via the server per viewer instance data object.

18. A web page element updating system according to claim 17, wherein the comparator compares information at the web server such as at the single instance data object and/or the per-viewer instance data objects with the data in the store.

19. A web page element updating system according to claim 1, comprising a database, on another server, which the processor is configured to update with data being sent to update the elements.

20. A web page element updating system according to claim 1, wherein the element is updated using dynamic hypertext mark up language (DHTML).

21. A web page element updating system according to claim 1, wherein elements are defined by div tags in the html of the primary web page

22. A web page element updating system according to claim 1, wherein their identifier comprises a div ID.

23. A web page element updating system according to claim 1, wherein the label comprises a div ID.

24. A web page element updating system according to claim 1, wherein the central memory comprises multiple memory sources on multiple computers servers in communication with each other such as the web servers of claim 14.

25. A web page element updating system according to claim 1, wherein the processor is configured so as to comprise the comparator, and/or correlator.

26. A web page element updating system according to claim 1, comprising a temporary connection between the central memory and the embedded web page, the central data memory being in communication with the embedded web page over the temporary connection, wherein a temporary connection is created whenever data needs to be or is requested to be transferred between them and may be terminated when it does not or is not.

27. A method of updating an element in a web page comprising the steps of:
associating a label with an element of a primary web page, providing an embedded web page within the primary web page containing data at least part of which has an identifier corresponding to the label of the element, updating the data in the embedded web page from a central source, obtaining data from the embedded web page and supplying a selected part of the data to the element by correlating the identifier with the label.

28. A method of running a falling- or rising-price auction comprising the steps of displaying events in the auction via an element or elements on a plurality of web pages, wherein change to prices in the auction are displayed by updating the element(s) according to the method of claim 27.

29. A method of running an auction comprising the steps of displaying events in the auction via an element or elements on a plurality of web pages and via another media, wherein new events occurring on the other media are presented to viewers of the web pages at a controlled time and substantially simultaneously to the viewers of the another media by updating the element(s) according to the method of claim 26.

30. A method according to claim 29, wherein the another media is a television channel.
